(19) United States
(12) Patent Application Publication
(10) Pub. No.: US 2014/0267804 A1
(43) Pub. Date: Sep. 18, 2014

(54) TOMOGRAPHIC IMAGING SYSTEM WITH INTEGRATED MICROSURGERY STABILIZATION TOOL

(71) Applicant: VOLCANO CORPORATION, San Diego, CA (US)

(72) Inventors: Nathaniel J. Kemp, Concord, MA (US); David Sheehan, Poway, CA (US)

(73) Assignee: VOLCANO CORPORATION, San Diego, CA (US)

(21) Appl. No.: 14/206,578

(22) Filed: Mar. 12, 2014

Related U.S. Application Data
(60) Provisional application No. 61/778,581, filed on Mar. 13, 2013.

(51) Int. Cl. H04N 5/232

(52) U.S. Cl. CPC H04N 5/232
USPC 348/208.2

(57) ABSTRACT

The invention relates to medical intervention systems with integrated imaging and microsurgery subsystems, in which the microsurgery subsystem employs hardware that is used for imaging in the imaging subsystem to provide a stabilization feedback loop to prevent unwanted vibrations or motions in a microsurgery tool.

This application claims the benefit of, and priority to, U.S. Provisional Patent Application No. 61/778,581, filed Mar. 13, 2013, which is incorporated by reference.

### FIELD OF THE INVENTION

The invention generally relates to intravascular imaging and microsurgery integrated systems.

### BACKGROUND

Illness or injury can be relieved by medical intervention. Doctors use tools to study and treat injuries and the causes of illness. For example, tomographic imaging includes methods of studying tissue within a patient via an imaging system that collect “slices” of data and put them together to reveal the condition of the tissue. Treatment can include surgical techniques such as microsurgery. Microsurgery involves small surgical tools that are used to investigate and treat affected tissue.

In some senses, tomographic imaging and microsurgery complement one another. A tomographic imaging system could be used to produce a 3D image of an affected site within tissue, and that image could aid a surgeon in performing microsurgery. Unfortunately, these systems are very expensive. Not all clinics can afford to build up a tomographic examination system and also a microsurgery system. Some microsurgery systems are complicated and include computer-controlled opto-electrical systems that promise very high quality results. Due to the high cost of such systems, hospitals may have to be parsimonious in obtaining and deploying such systems.

### SUMMARY

The invention relates to medical intervention systems with integrated imaging and microsurgery subsystems, in which the microsurgery subsystem employs hardware that is used for imaging in the imaging subsystem to provide a stabilization feedback loop to prevent unwanted vibrations or motions in a microsurgery tool. The cost of the microsurgery subsystem is shared with the cost of the tomographic imaging system by integrating common components between the subsystems. In this fashion, microsurgery stabilization tools can be provided to complement tomographic imaging systems and tomographic imaging systems can be provided to complement microsurgery stabilization tools. This increases the availability of these systems to hospitals, allowing more patients to be treated by these complementary intervention techniques. As a result, illness and injury is relieved for a greater number of people.

In certain aspects, the invention provides a medical intervention system that includes a light source, an imaging subsystem coupled to the light source, and a microsurgery tool coupled to the light source and comprising a motor to compensate for unwanted vibrations applied to the tool. The imaging subsystem may be an OCT system, IVUS, or photoacoustic imaging. In some embodiments, the imaging subsystem includes an intravascular imaging catheter operably coupled to the light source via a patient interface module (PIM), wherein the interface module comprises a mechanism to control an imaging operation such as a pullback. The interface module may initiate a catheter pullback.

### BRIEF DESCRIPTION OF THE DRAWINGS

FIG. 1 shows a medical intervention system.

FIG. 2 is a diagram of components of an OCT system.

FIG. 3 gives a detailed view of an OCT imaging engine.

FIG. 4 is a schematic of an OCT patient interface module.

FIG. 5 shows a pattern that an OCT imaging fiber traces during a pullback.

FIG. 6 diagrams a pattern of scan lines produced by an imaging operation.

FIG. 7 is a reproduction of a display from an intravascular imaging system.

FIG. 8 is an illustration of a display from an intravascular imaging system.

FIG. 9 diagrams a method of flush-triggered imaging according to certain embodiments.

FIG. 10 shows a method for angio-triggered imaging.

FIG. 11 gives a diagram of components of an IVUS system.

FIG. 12 shows an IVUS control station.

FIG. 13 is a schematic of components within an IVUS system.

FIG. 14 depicts a microsurgery stabilization tool.

FIG. 15 shows a microsurgery subsystem.

### DETAILED DESCRIPTION

Systems of the invention include a shared hardware platform that provides both microsurgery stabilization and tomographic imaging. The invention provides a medical intervention system that includes integrated microsurgery stabilization (e.g., including a proximity, location, or motion sensor as input within a feedback loop) and general tomographic imaging system. A medical intervention system integrating a closed-loop microsurgical stabilization tool with general tomographic imaging offers beneficial therapy guidance capabilities. A medical intervention system integrates a closed-loop microsurgical stabilization tool (e.g. see Song, et al., 2012, Active tremor cancellation by a “Smart” handheld virtreoretinal microsurgical tool using swept source optical coherence tomography, Optics Express 20(21):23414-23421), which uses feedback from an optical or acoustic sensor to correct unwanted motion during delicate surgical tasks such as cutting with a scalpel, with a general imaging and therapy guidance platform (e.g. the Volcano s5i system from Volcano Corporation), which generates high-resolution tomographic images of samples using OCT or ultrasound.

An optical-based microsurgery stabilization tool may employ optical frequency domain reflectometery (OFDR) to sense and then correct for (stabilize) uncontrolled motion between a surgical tool and the operative tissue, as discussed in greater detail with respect to FIGS. 14 and 15 below. Basic swept-source stabilization system hardware components may include power supply electronics, tunable light source and associated drivers, fiber-optic interferometer, photo-receiver(s), and data acquisition/processing electronics.

Swept-source OCT imaging systems use primarily the same hardware components to perform tomographic imaging prior-to and during surgical procedures. Commercial OCT systems may be used in various surgical facilities and are described in greater detail below.

The combined system disclosed here shares these expensive hardware components for both microsurgical stabilization and also tomographic imaging applications. The surgical tool (disposable or non-disposable) and the imaging probe or scanner (disposable or non-disposable) both plug into the shared system instrumentation and can be used concurrently or sequentially, depending on the application and specific embodiment.

Shared hardware provides several advantages in terms of component costs, physical size of system hardware within the surgical theater, optimized surgical workflow, and other business efficiencies. Thus the invention leverages similarities between general diagnostic imaging tools (e.g. OCT) and microsurgery stabilization systems to share components and reduce system hardware costs.

A variety of surgical tools may be included in a microsurgery subsystem including, for example, mechanical scalpels, laser scalpels, RF scalpels, syringe needles, CTO ablation tools, angioplasty treatment delivery, others, or a combination thereof. Microsurgical tools may be handheld by the surgeon or robotically instrumented. Sensing via sensor for microsurgery stabilization may be optical (OCT/OFDR), ultrasound, acoustic, photoacoustic, magnetic, or any other suitable modality known in the art. OCT/OFDR embodiments of the system may be either swept-source or spectrometer-based system architecture.

An integrated intervention system comprising imaging subsystems and microsurgery subsystems may provide a range of different surgical applications including ophthalmology, orthopedics and rheumatology, neurosurgery, vascular surgery, neurovascular surgery, others, or a combination thereof. Additionally, systems of the invention may have applications in non-surgical applications where micro assembly is improved by closed-loop stabilization.

The invention provides systems and methods for coordinating operations during intravascular imaging. Any intravascular imaging system may be used in systems and methods of the invention. Systems and methods of the invention have application in intravascular imaging methodologies such as intravascular ultrasound (IVUS) and optical coherence tomography (OCT) among others that produce a three-dimensional image of a vessel.

FIG. 1 depicts an exemplary layout of an intravascular imaging system 101 as may be found, for example, in a catheter lab. An operator uses control station and navigational device 125 to operate catheter 112 via patient interface module (PIM) 105. At a distal tip of catheter 112 is imaging tip 114. Computer device 120 works with PIM 105 to coordinate imaging operations. Imaging operations proceed by using catheter 112 to image the patient's tissue. The image data is received by device 120 and interpreted to provide an image on monitor 103. System 101 is operable for use during diagnostic imaging of the peripheral and coronary vasculature of the patient. System 101 can be configured to automatically visualize boundary features, perform spectral analysis of vascular features, provide qualitative or quantitate blood flow data, or a combination thereof.

In some embodiments, operation of system 101 employs a sterile, single use intravascular ultrasound imaging catheter 112. Catheter 112 is inserted into the coronary arteries and vessels of the peripheral vasculature under the guidance of angiogrpahic system 107. System 101 may be integrated into existing and newly installed catheter laboratories (angiography suites.) The system configuration is flexible in order to fit into the existing catheter laboratory work flow and environment. For example, the system can include industry standard input/output interfaces for hardware such as navigation device 125, which can be a bedside mounted joystick. System 101 can include interfaces for one or more of an EKG system, exam room monitor, bedside rail mounted monitor, ceiling mounted exam room monitor, and server room computer hardware.

System 101 connects to catheter 112 via PIM 105, which may contain a type CF (intended for direct cardiac application) defibrillator proof isolation boundary. All other input/output interfaces within the patient environment may utilize both primary and secondary protective earth connections to limit enclosure leakage currents. The primary protective earth connection for controller 125 and control station 110 can be provided through the bedside rail mount. A secondary connection may be via a safety ground wire directly to the bedside protective earth system. Monitor 103 and an EKG interface can utilize the existing protective earth connections of the monitor and EKG system and a secondary protective earth connection from the bedside protective earth bus to the main chassis potential equalization post.

Computer device 120 can include a high performance dual Xeon based system using an operating system such as Windows XP professional or Windows 8. Computer device 120 may be configured to perform real time intravascular ultrasound imaging while simultaneously running a tissue classification algorithm referred to as virtual histology (VH). The application software can include a DICOM3 compliant interface, a work list client interface, interfaces for connection to angiographic systems, or a combination thereof. Computer device 120 may be located in a separate control room, the exam room, or in an equipment room and may be coupled to one or more of a custom control station, a second control station, a joystick controller, a PS2 keyboard with touchpad, a mouse, or any other computer control device.

Computer device 120 may generally include one or more USB or similar interfaces for connecting peripheral equipment. Available USB devices for connection include the custom control stations, the joystick, and a color printer. In some embodiments, control system includes one or more of a USB 2.0 high speed interface, a 50/100/1000 baseT Ethernet network interface, AC power input, PS2 jack, potential equalization post, 1 GigE Ethernet interface, microphone & line inputs, line output VGA Video, DVI video interface, PIM interface, ECG interface, other connections, or a combination thereof. As shown in FIG. 1, computer device 120 is generally linked to control station 110.

Control station 110 may be provided by any suitable device, such as a computer terminal (e.g., on a kiosk). In some embodiments, control system 110 is a purpose built device with a custom form factor (e.g., as shown in FIG. 12).

In certain embodiments, systems and methods of the invention include processing hardware configured to interact with more than one different three dimensional imaging system so that the tissue imaging devices and methods described here in can be alternatively used with OCT, IVUS, or other hardware.

Any target can be imaged by methods and systems of the invention including, for example, bodily tissue. In certain embodiments, systems and methods of the invention image within a lumen of tissue. Various lumen of biological structures may be imaged including, but not limited to, blood vessels, vasculature of the lymphatic and nervous systems, various structures of the gastrointestinal tract including lumen of the small intestine, large intestine, stomach, esophagus, colon, pancreatic duct, bile duct, hepatic duct, lumen of the reproductive tract including the vas deferens, vagina, uterus and fallopian tubes, structures of the urinary tract including urinary collecting ducts, renal tubules, ureter, and bladder, and structures of the head and neck and pulmonary system including sinuses, parotid, trachea, bronchi, and lungs.

In an exemplary embodiment, the invention provides a system for capturing a three dimensional image by OCT. Commercially available OCT systems are employed in diverse applications such as art conservation and diagnostic medicine, e.g., ophthalmology. OCT is also used in interventional cardiology, for example, to help diagnose coronary artery disease. OCT systems and methods are described in U.S. Pub. 2011/0152771; U.S. Pub. 2010/0220334; U.S. Pub. 2009/0043191; U.S. Pub. 2008/0291463; and U.S. Pub. 2008/0180683, the contents of each of which are hereby incorporated by reference in their entirety.

In OCT, a light source delivers a beam of light to an imaging device to image target tissue. Within the light source is an optical amplifier and a tunable filter that allows a user to select a wavelength of light to be amplified. Wavelengths commonly used in medical applications include near-infrared light, for example between about 800 nm and about 1700 nm.

Generally, there are two types of OCT systems, common beam path systems and differential beam path systems, that differ from each other based upon the optical layout of the systems. A common beam path system sends all produced light through a single optical fiber to generate a reference signal and a sample signal whereas a differential beam path system splits the produced light such that a portion of the light is directed to the sample and the other portion is directed to a reference surface. Common beam path interferometers are further described for example in U.S. Pat. No. 7,999,938; U.S. Pat. No. 7,995,210; and U.S. Pat. No. 7,787,127, the contents of each of which are incorporated by reference herein in its entirety.

In a differential beam path system, amplified light from a light source is input into an interferometer with a portion of light directed to a sample and the other portion directed to a reference surface. A distal end of an optical fiber is interfaced with a catheter for interrogation of the target tissue during a catheterization procedure. The reflected light from the tissue is recombined with the signal from the reference surface forming interference fringes (measured by a photovoltaic detector) allowing precise depth-resolved imaging of the target tissue on a micron scale. Exemplary differential beam path interferometers are Mach-Zehnder interferometers and Michelson interferometers. Differential beam path interferometers are further described for example in U.S. Pat. No. 7,783,337; U.S. Pat. No. 6,134,003; and U.S. Pat. No. 6,421,164, the contents of each of which are incorporated by reference herein in its entirety.

FIG. 2 presents a high-level diagram of a differential beam path OCT system according to certain embodiments of the invention. For intravascular imaging, a light beam is delivered to the vessel lumen via a fiber-optic based imaging catheter 826. The imaging catheter is connected through hardware to software on a host workstation. The hardware includes an imagining engine 859 and a handheld patient interface module (PIM) 839 that includes user controls. The proximal end of the imaging catheter is connected to PIM 839, which is connected to an imaging engine as shown in FIG. 3.

FIG. 3 gives a detailed view of components of imaging engine 859 (e.g., a bedside unit). Imaging engine 859 houses a power supply 849, light source 827, interferometer 931, and variable delay line 835 as well as a data acquisition (DAQ) board 855 and optical controller board (OCB) 854. A PIM cable 841 connects the imagine engine 859 to the PIM 839 and an engine cable 845 connects the imaging engine 859 to the host workstation.

FIG. 4 shows light path in a differential beam path system according to an exemplary embodiment of the invention. Light for image capture originates within the light source 827. This light is split between an OCT interferometer 905 and an auxiliary, or “clock”, interferometer 911. Light directed to the OCT interferometer is further split by splitter 917 and recombined by splitter 919 with an asymmetric split ratio. The majority of the light is guided into the sample path 913 and the remainder into a reference path 915. The sample path includes optical fibers running through the PIM 839 and the imaging catheter 826 and terminating at the distal end of the imaging catheter where the image is captured.

Typical intravascular OCT involves introducing the imaging catheter into a patient's target vessel using standard interventional techniques and tools such as a guide wire, guide catheter, and angiography system. Rotation is driven by spin motor 861 while translation is driven by pullback motor 865.

FIG. 5 describes the motion for image capture defined by rotation and translation. Blood in the vessel is temporarily flushed with a clear solution for imaging. Detection of the flushing (see, e.g., FIG. 9 or 10) triggers, via the PIM or control console, the imaging core of the catheter to rotate, pullback, or both while collecting image data that it delivers to the console screen. Using light provided by the imaging engine, the inner core sends light into the tissue in an array of A scan lines as illustrated in FIG. 6 and detects reflected light.

FIG. 6 shows the positioning of A scans with in a vessel. Each place where one of A scans A11, A12, . . . , AN intersects a surface of a feature within vessel 101 (e.g., a vessel wall) coherent light is reflected and detected. Catheter 826 translates along axis 117 being pushed or pulled by pullback motor 865.

The reflected, detected light is transmitted along a sample path of interferometer 831 to be recombined with the light from reference path via a splitter. A variable delay line (VDL) 925 on the reference path uses an adjustable fiber coil to match the length of reference path to the length of sample path. The reference path length may adjusted by a stepper motor translating a minor on a translation stage under the control of firmware or software. The free-space optical beam on the inside of the VDL 925 experiences more delay as the minor moves away from the fixed input/output fiber.

The combined light from the splitter is split into orthogonal polarization states, resulting in RF-band polarization-diverse temporal interference fringe signals. The interference fringe signals are converted to photocurrents using PIN photodiodes on the OCB 851 as shown in FIG. 3. The interfering, polarization splitting, and detection steps are done by a polarization diversity module (PDM) on the OCB. Signal from the OCB is sent to the DAQ 855, shown in FIG. 3. The DAQ includes a digital signal processing (DSP) microprocessor and a field programmable gate array (FPGA) to digitize signals and communicate with the host workstation and the PIM. The FPGA converts raw optical interference signals into meaningful OCT images. The DAQ also compresses data as necessary to reduce image transfer bandwidth to 1 Gbps (e.g., compressing frames with a lossy compression JPEG encoder).

Data is collected from A scans A11, A12, . . . , AN and stored in a tangible, non-transitory memory. A set of A scans generally define a B scan. The data of all the A scan lines together represent a three-dimensional image of the tissue. The data of the A scan lines generally referred to as a B scan can be used to create an image of a cross section of the tissue, sometimes referred to as a tomographic view. The data of the A scan lines is processed according to systems and methods of the inventions to generate images of the tissue. By processing the data appropriately (e.g., by fast Fourier transformation), a two-dimensional image can be prepared from the three dimensional data set. Systems and methods of the invention provide one or more of a tomographic view, ILD, or both.

FIG. 7 shows a display 237 including a tomographic view in the left panel. A tomographic view can be represented as a visual depiction of a cross section of a vessel (see left side of FIG. 7). Where a tomographic view generally represents an image as a planar view across a vessel or other tissue (i.e., normal to axis 117), an image can also be represented as a planar view along a vessel (i.e., axis 117 lies in the plane of the view).

FIG. 7 shows a longitudinal planar view of the vessel in the right panel. Such a planar image along a vessel is sometimes referred to as an in-line digital view or image longitudinal display (ILD). The system captures a 3D data set that is used to present the image of tissue. An electronic apparatus within the system (e.g., PC, dedicated hardware, or firmware) stores the three dimensional data set in a tangible, non-transitory memory and renders a display 237 (e.g., on a screen or computer monitor) that includes a 2D image of the tissue.

FIG. 8 shows a display similar to that shown in FIG. 7, rendered in a simplified style of the purposes of ease of understanding. Display 237 may be rendered within a windows-based operating system environment, such as Windows, Mac OS, or Linux or within a display or GUI of a specialized system. Display 237 can include any standard controls associated with a display (e.g., within a windowing environment) including minimize and close buttons, scroll bars, menus, and window resizing controls. Elements of display 237 can be provided by an operating system, windows environment, application programming interface (API), web browser, program, or combination thereof (for example, in some embodiments a computer includes an operating system in which an independent program such as a web browser runs and the independent program supplies one or more of an API to render elements of a GUI). Display 237 can further include any controls or information related to viewing images (e.g., zoom, color controls, brightness/contrast) or handling files comprising three-dimensional image data (e.g., open, save, close, select, cut, delete, etc.). Further, display 237 can include controls (e.g., buttons, sliders, tabs, switches) related to operating a three dimensional image capture system (e.g., go, stop, pause, power up, power down). As shown in FIG. 8, display 237 includes two images of tissue, a tomographic view and an ILD. As discussed above, intravascular imaging provides a very good display when blood is flushed from the vessel. The clarity of display 237 as shown in FIG. 7 and drawn in FIG. 8 relates to the ability of the imaging modality to see through the surrounding media and to the affected tissue. In high frequency IVUS, discussed in greater detail below, the imaging involves ultrasonic signals that must penetrate through the media. In OCT, the imaging involves light signals. So that the imaging signal can propagate most directly to the tissue and back, a flush operation replaces the blood with a solution that is transparent to the imaging signal (e.g., saline). Thus, the medium surrounding the image capture device does not interfere with the imaging operation. Additionally, so that image capture is well synchronized and a useful data set can be captured on every operation, the flush operation is used as the direct trigger of the image capture operation.

FIG. 9 diagrams a method of flush-triggered imaging applicable in, for example, OCT. Once the imaging catheter is inserted to the site to be imaged, a detection mechanism on or near the imaging catheter is used. The detection mechanism can be the light path of the OCT system itself, a dedicated pressure sensor on the OCT catheter, an angiographic system, or any other suitable system. Since successfully flushing blood out of a vessel can involve pushing in a solution at a higher pressure than the blood, a pressure detector can be used to detect the flush. Intravascular blood pressure detectors can operate via piezoelectric or similar detection elements. Suitable blood pressure detectors are discussed in U.S. Pat. No. 7,335,161; U.S. Pat. No. 6,886,411; U.S. Pat. No. 6,504,286; U.S. Pat. No. 5,873,835; U.S. Pub. 2009/0270695; and U.S. Pub. 2005/0197585, the contents of which are incorporated by reference herein in their entirety. The influx of solution causes a clearly-detectable spike in blood pressure. In the vessel, at or near the catheter, the change in blood pressure is detected. The pressure detector need not be directly on the catheter (although that may be one suitable place for it). It may be on a dedicated catheter, on a guidewire, implanted, injected, or otherwise positioned.

Where the detection mechanism is optical—for example, the OCT light path and detection circuitry is used to detect the displacement of blood by solution (e.g., transition from dark to light), the OCT imaging tip is operating optically as the solution is flushed in. A processor in the OCT imaging engine can detect a change in light by digital signal processing techniques. Whether the detection is optical, pressure based, ultrasound based, other, or a combination thereof, the detection at the catheter end of the system operates as a trigger at the control end of the system to initiate the OCT catheter pullback. During pullback, the OCT systems captures an image of the tissue (e.g., the in the form of a 3D data set) by sending the interferometric signal back to the system. The system receives the image and processes it for storage or presentation as a display 237. Additionally or alternatively, the flush can be detected from outside of the vessel (e.g., outside of the body). Any suitable external detection method can be employed, such as a blood pressure cuff or an angiography system.

FIG. 10 shows a method for angio-triggered imaging. Here, an angiography system is used with the imaging system (e.g., OCT, IVUS, or optical-acoustic imaging). Angiography systems can be used to visualize the blood vessels by injecting a radio-opaque contrast agent into the blood vessel and imaging using X-ray based techniques such as fluoroscopy. Angiographic techniques include projection radiography as well as imaging techniques such as CT angiography and MR angiography. In certain embodiments, angiography involves using a catheter to administer the x-ray contrast agent at the desired area to be visualized. The catheter is threaded into an artery, and the tip is advanced through the arterial system into the major coronary artery. X-ray images of the transient radio contrast distribution within the blood flowing within the coronary arteries allows visualization of the size of the artery openings. Features and media within the blood and walls of the arteries are studied. Angiography systems and methods are discussed, for example, in U.S. Pat. No. 7,734,009; U.S. Pat. No. 7,564,949; U.S. Pat. No. 6,520,677; U.S. Pat. No. 5,848,121; U.S. Pat. No. 5,346,689; U.S. Pat. No. 5,266,302; U.S. Pat. No. 4,432,370; and U.S. Pub. 2011/0301684, the contents of each of which are incorporated by reference in their entirety for all purposes.

As shown in FIG. 10, the angiography system can be used to detect a change. The angiography system can be used to detect the flush with saline (e.g., the temporary displacement of the radiopaque dye by the saline), the initial influx of radiopaque dye, or other such flushes. A processor that receives the angiography signal data can detect a brightness or contrast change (e.g., by digital signal processing techniques including those described in Smith, 1997, THE SCIENTIST AND ENGINEERS GUIDE TO DIGITAL SIGNAL PROCESSING, California Technical Publishing (San Diego, Calif.) 626 pages, the contents of which are hereby incorporated by reference). The imaging system uses the flush detection as a trigger to initiate pullback and image capture via the imaging catheter. The imaging system then receives the image.

Flush triggered imaging may have particular application in IVUS. For example, high-frequency IVUS can detect speckling from the blood and can benefit from flushing the blood from the system with a clear (to IVUS) solution. In certain embodiments, the invention provides systems and methods for flush-triggered IVUS imaging.

IVUS uses a catheter with an ultrasound probe attached at the distal end. The proximal end of the catheter is attached to computerized ultrasound equipment. To visualize a vessel via IVUS, angiographic techniques are used and the physician positions the tip of a guide wire, usually 0.36 mm (0.014″) diameter and about 200 cm long. The physician steers the guide wire from outside the body, through angiography catheters and into the blood vessel branch to be imaged.

The ultrasound catheter tip is slid in over the guide wire and positioned, again, using angiography techniques, so that the tip is at the farthest away position to be imaged. Sound waves are emitted from the catheter tip (e.g., in about a 20-40 MHz range) and the catheter also receives and conducts the return echo information out to the external computerized ultrasound equipment, which constructs and displays a real time ultrasound image of a thin section of the blood vessel currently surrounding the catheter tip, usually displayed at 30 frames/second image.

The guide wire is kept stationary and the ultrasound catheter tip is slid backwards, usually under motorized control at a pullback speed of 0.5 mm/s. Systems for IVUS are discussed in U.S. Pat. No. 5,771,895; U.S. Pub. 2009/0284332; U.S. Pub. 2009/0195514 A1; U.S. Pub. 2007/0232933; and U.S. Pub. 2005/0249391, the contents of each of which are hereby incorporated by reference in their entirety. Imaging tissue by IVUS produces tomographic (cross-sectional) or ILD images, for example, as illustrated in FIG. 8 and shown in FIG. 7. An IVUS system can be installed substantially as shown in FIG. 1. An IVUS computer device 520 takes the place of OCT computer device 120.

FIG. 11 describes an exemplary computer device 520 according to certain embodiments. Computer device 520 may include a motherboard 529 that includes an IVUS signal generation and processing system. The signal generation and processing system may comprises an analog printed circuit assembly (PCA) 131, an digital PCA 133, one or more filter modules, and a VH board 535. Analog PCA 131 and digital PCA 133 are used to excite transducer 514 via catheter 512 and to receive and process the gray scale IVUS signals. The VH board 535 is used to capture and pre-process the IVUS RF signals and transfer them to the main VH processing algorithm as run by a computer processor system (e.g., dual Xeon processors). PIM 105 is directly connected to the analog PCA 131.

FIG. 12 shows a control station 510 according to certain embodiments. A slide out keyboard is located on the bottom for manual text entry. Control station 510 may be designed for different installations options. The station can be placed directly on a desktop surface. With an optional bedside mounting kit, control station 510 can be affixed directly to the bedside rail. Control station 510 can include a standard four hole VESA mount on the underside to allow other mounting configurations. Control system 510 may provide a simple-to-use interface with frequently-operated functions mapped to unique switches. Control station 510 may be powered from, and may communicate with, computer 520 using a standard USB 1.1 interface. The system may include a control panel 515. In some embodiments, multiple control panels 515 are mounted in both the exam room and/or the control room. Control system 510 can have a surface control panel with buttons for frequently-operated functions (e.g., as contact closure switches). Those dome switches are covered with a membrane overlay. The use of dome switches provides a tactile feedback to the operator upon closure. The control panel may include a pointing device such as a trackball to navigate a pointer on the graphical user interface of the system. The control panel may include several screen selection keys. The settings key is used to change system settings like date and time and also permits setting and editing default configurations. The display key may be used to provide enlarged view for printing. In some embodiments, the print key prints a 6×4 inch photo of the current image on the screen. The control panel may include a Ring Down key that toggles the operation of ringdown subtraction. A chroma key can turn blood flow operations on and off. The VH key can operate the virtual histology engine. A record, stop, play, and save frame key are included for video operation. Typically, the home key will operate to display the live image. A menu key provides access to measurement options such as diameter, length, and borders. Bookmark can be used while recording a loop to select specific areas of interest. Select (+) and Menu (−) keys are used to make selections.

In some embodiments, the system includes a joystick for navigational device 525. The joystick may be a sealed off-the-shelf USB pointing device used to move the cursor on the graphical user interface from the bedside. System 501 may include a control room monitor, e.g., an off-the-shelf 59″ flat panel monitor with a native pixel resolution of 5280×1024 to accept DVI-D, DVI-I and VGA video inputs.

Control station 510 is operably coupled to PIM 105, from which catheter 512 extends. Catheter 512 includes an ultrasound transducer 514 located at the tip. Any suitable IVUS transducer may be used. For example, in some embodiments, transducer 514 is driven as a synthetic aperture imaging element. Imaging transducer 514 may be approximately 5 mm in diameter and 2.5 mm in length. In certain embodiments, transducer 514 includes a piezoelectric component such as, for example, lead zirconium nitrate or PZT ceramic. The transducer may be provided as an array of elements (e.g., 64), for example, bonded to a Kapton flexible circuit board providing one or more integrated circuits. This printed circuit assembly may rolled around a central metal tube, back filled with an acoustic backing material and bonded to the tip of catheter 514. In some embodiments, signals are passed to the system via a plurality of wires (e.g., 7) that run the full length of catheter 512. The wires are bonded to the transducer flex circuit at one end and to a mating connector in PIM 105 at the other. The PIM connector may also contains a configuration EPROM. The EPROM may contain the catheter's model and serial numbers and the calibration coefficients which are used by the system. The PIM 105 provides the patient electrical isolation, the beam steering, and the RF amplification. PIM 105 may additionally include a local microcontroller to monitor the performance of the system and reset the PIM to a known safe state in the event of loss of communication or system failure. PIM 105 may communicate with computer device 520 via a low speed RS232 serial link.

FIG. 13 provides a schematic of analog PCA 131 and digital PCA 133 according to certain embodiments of the invention. Analog PCA 131 is shown to include amplifier 541, band pass filter 545, mixer 549, low pass filter 553, and analog-to-digital converter (ADC) 157. (Here, the system is depicted as being operable to convert the transducer RF data to “In-Phase” and “Quadrature” (IQ) data. According to this embodiment, ADC 157 is 52-bits wide and converts the IQ data to a dual digital data stream.) Analog board 531 further includes an interface module 561 for PIM 105, as well as a clock device 569.

Digital PCA 133 is depicted as having an acquisition FPGA 165, as well as a focus FPGA 171, and a scan conversion FPGA 179. Focus FPGA 171 provides the synthetic aperture signal processing and scan conversion FPGA 179 provides the final scan conversion of the transducer vector data to Cartesian coordinates suitable for display via a standard computer graphics card on monitor 503. Digital board 533 further optionally includes a safety microcontroller 581, operable to shut down PIM 105 as a failsafe mechanism. Preferably, digital PCA 133 further includes a PCI interface chip 575. It will be appreciated that this provides but one exemplary illustrative embodiment and that one or skill in the art will recognize that variant and alternative arrangements may perform the functions described herein. Clock device 569 and acquisition FPGA 165 operate in synchronization to control the transmission of acquisition sequences. FIG. 13 presents one exemplary system architecture, and other IVUS systems are known in the art and may be used for flush-triggered IVUS imaging. For flush-triggered imaging, the blood is displaced by a solution, and this flushing step is detected. Any suitable detection mechanism can be used including, for example, blood pressure or angio systems as discussed above.

Systems and methods of the invention include microsurgery stabilization tools integrated with tomographic imaging operations. Microsurgery stabilization can cancel vibrations or tremors from a user's hand. A tool for microsurgery stabilization uses OCT or a similar imaging modality. In some embodiments, the invention includes a common path, swept source optical coherence tomography-based microsurgery tool that actively suppresses surgeon hand tremor. The system stabilizes the tool tip, allowing for more accurate and less risky procedures.

Tomographic imaging system such as OCT can also be used as very precise distance, motion or proximity sensor with high speed in medical applications. Fiber optic based common path optical coherence tomography (CP-OCT) may be a preferred modality. CP-OCT is based on a single arm interferometer design where the reference and the sample arms share a common path. Fabry-Perot interferometry-based fiber-optic force sensor tools can utilize common path Fourier domain optical coherence tomography. In fact, a microsurgery stabilization tool of the invention can aid in performing one or more of surface topology and motion tracking, micro-incision, micromanipulation,

In certain embodiments, the microsurgery stabilization tool includes common path, swept source optical coherence tomography (CP SS-OCT) in a surgical tool that effectively cancels undesirable surgeon hand tremor, unintended instrument drift, and responds to surgical target motion. An exemplary tool that may be modified for use with the invention is described in Song, et al., 2012, Active tremor cancellation by a “Smart” handheld virtreoretinal microsurgical tool using swept source optical coherence tomography, Optics Express 20(21):23414-23421. In certain embodiments, the invention provides a CP SS-OCT based smart handheld surgical tool such as the one described by Song, et al. (2012). Aspects of the tool include surface-sensing and tremor compensation capabilities and are accomplished by coupling a fiber optic CP-OCT sensing ability with a piezoelectric motor response element.

FIG. 14 shows a microsurgery stabilization tool 601. Tool 601 includes front holder 621, back holder 609, joint 607, tail 613, outer needle 625, inner needle 627, piezoelectric motor 633, luer-lock combination 629, and optical fiber 605.

Tool 601 may include commercial syringe needles (20-gauge and 25-gauge, BD syringe) for outer needle 625, inner needle 627, or both. Piezoelectric motor 633 (LEGS-L01S-11, PiezoMotor) may provide a main operational components of tool 601. Tool 601 may include a cover of one or more (e.g., four) separate parts. In some embodiments, the cover includes front holder 621, back holder 609, tail 613, and joint 307. The design can be further reduced to simplify the manufacturing and assembly. Useful combinations for the front holder and motor drive rod may be achieved by introducing two or more luer-lock hypodermic needles. The inner needle 627 may be combined with the motor drive rod while outer needle 625 may be coupled with the front holder. The function of outer needle 625 is as a drive supporter of inner needle 627.

As described by Song, et al. (2012), a bare single-mode fiber 605 for real-time distance sensing between the surgical needle tip and the surgical target extends through inner needle 627. The joint part may include a small hole through which a single-mode fiber (SMF28, Corning) may pass to allow for OCT signal acquisition. Tool 601 can include a connection medium between inner needle 627 and the motor drive rod. In some embodiments, piezoelectric motor 633 has a maximum speed of about 20 mm/s, maximum stroke of about 55 mm, maximum force of about 6.5 N, and a resolution of less than about 1 nm. The motor in the back holder can be positioned by mechanical components. The minimum cross-sectional area of the tool depends primarily on the motor dimensions (22 mm×10.8 mm×18.7 mm). In certain embodiments, tool 601 has a length of 140 mm excluding the surgical needle and a weight of about 65 g, including the motor weight of 20 g. Front holder 621 may allow an inner needle travel range of 12 mm.

FIG. 15 shows the imaging system for microsurgery tool 601 including light source 827 (e.g., a swept source), an optical assembly 831 (e.g., an interferometer or circulator), and a data acquisition board 855 (e.g., containing one or more photodiode or other photodetector). The laser beam is directed to the smart surgical tool through the optical assembly 831, and the common path interference beam returning through the distal end of the single mode fiber and the sample is redirected to the photodiode on DAQ 855 for a distance sensing. The system may include the CP SS-OCT as a high-speed high-precision fiber-optic distance sensor to locate a surgical tip at the desired position by measuring an exact height between the surgical needle tip and the sample surface. A distal end of the single mode fiber may be used as a reference plane.

In some embodiments, light source 827 (e.g., a swept source laser from Axsun Technologies, Inc., a semiconductor optical amplifier, etc.) has a sweep repetition rate of about 50 kHz, a center wavelength of about 1310 nm, and a bandwidth of about 110 nm providing an experimental axial resolution of about 16 μm. The spectral interference detected by a photodiode on DAQ 855 is transferred to the controller subsystem 649 by a high-speed dual channel digitizer (AlazarTech, ATS9350), with one frame composed of 100 A-lines. One A-line with a processing speed of 500 frames per second may be used from 100 A-lines to sense the height. The DC components in the interference signal may be eliminated by subtracting the low-pass filtered signal after ensemble averaging from the one selected A-line. The digitizer (e.g., on DAQ 855) may achieve real-time acquisition with a 12-bit resolution and a sampling rate of 500 MS/s, with an 8-lane PCI Express. Controller subsystem 649 may handle high-speed data processing of OCT signals and may communicate with a motor control driver 641.

FIG. 15 gives a schematic of a microsurgery stabilization system integrated into a control system 110 of a tomographic imaging system to beneficial use components of imaging engine 859. Methods of microsurgery stabilization can operate by a feedback control loop. In a feedback control loop microsurgery stabilization method, when the initialization of inner surgical needle 627 is necessary including the first usage, the needle 627 is moved to the middle of the travel range: 12 mm. An edge detection method searching for first surface of the sample may be achieved by low-pass filtering of the Fourier transformed A-line OCT signal from the multi-layered and amorphous sample (e.g., as described in Song, et al., 2012). The magnitude of the A-scan OCT signal exceeding a predetermined threshold only triggers the motion compensation. The motor may be idle with a weak OCT signal. To locate precisely the inner surgical needle to the target height, the motor movement may be controlled by adjusting motor velocity, motor step size, or a combination thereof. If there is exists a current position error, the motor may move forward and backwards if the error is negative. When the surgeon is holding the tool still or moving vertically, the feedback control system may be applied to keep the offset, e.g., a constant distance from a target. In some embodiments, the stabilized fiber optic based surgical tool 601 will allow for automated surgical tool actions from a defined offset height.

Systems and methods of the invention include a microsurgery stabilization tool that may be based on common path swept source optical coherence tomography. Tool 601 may be used to analyze tremors or vibrations. Tool 601 may provide a compensation system with closed-loop control, using edge-searching algorithms, for real-time depth tracking, limitation of tool motion, and motion compensation via piezoelectric motor 633 to detect and inhibit unwanted motion or vibration.

While discussed above in terms of flushing blood with a solution that can be clear, flush triggering is applicable to any flushing of a vessel. In some embodiments, the invention provides the coordination of angiography with intravascular imaging by using the injection of a radiopaque dye (e.g., for angiography) as the trigger for the intravascular imaging operation. It will be appreciated that methods described herein can be used to coordinate angiography to intravascular imaging. The angio system can detect the influx of radiopaque dye and use that detection as the trigger for an imaging operation.

Other embodiments are within the scope and spirit of the invention. For example, due to the nature of software, functions described above can be implemented using software, hardware, firmware, hardwiring, or combinations of any of these. Features implementing functions can also be physically located at various positions, including being distributed such that portions of functions are implemented at different physical locations.

Steps of the invention may be performed using a system comprising dedicated medical imaging hardware, general purpose computers, or both. As one skilled in the art would recognize as necessary or best-suited for performance of the methods of the invention, computer systems or machines of the invention include one or more processors (e.g., a central processing unit (CPU) a graphics processing unit (GPU) or both), a main memory and a static memory, which communicate with each other via a bus. A computer device generally includes non-transitory memory coupled to a processor and operable via an input/output device.

Exemplary input/output devices include a video display unit (e.g., a liquid crystal display (LCD) or a cathode ray tube (CRT)). Computer systems or machines according to the invention can also include an alphanumeric input device (e.g., a keyboard), a cursor control device (e.g., a mouse), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

Memory according to the invention can include a tangible, non-transitory machine-readable medium on which is stored one or more sets of instructions (e.g., software), data, or both embodying any one or more of the methodologies or functions described herein. The software may also reside, completely or at least partially, within the main memory and/or within the processor during execution thereof by the computer system, the main memory and the processor also constituting machine-readable media. The software may further be transmitted or received over a network via the network interface device.

While the machine-readable medium can in an exemplary embodiment be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the methodologies of the present invention. The term “machine-readable medium” shall accordingly be taken to include, but not be limited to, solid-state memories (e.g., subscriber identity module (SIM) card, secure digital card (SD card), micro SD card, or solid-state drive (SSD)), optical and magnetic media, and any other tangible storage media. Preferably, computer memory is a tangible, non-transitory medium, such as any of the foregoing, and may be operably coupled to a processor by a bus. Methods of the invention include writing data to memory—i.e., physically transforming arrangements of particles in computer memory so that the transformed tangible medium represents the tangible physical objects—e.g., the arterial plaque in a patient's vessel.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A medical intervention system comprising:
an imaging subsystem comprising an intravascular imaging instrument;
a stabilization tool coupled to the imaging instrument; and
a controller subsystem coupled to the stabilization tool and operable to cause the stabilization tool to compensate for vibrations of the imaging instrument.

2. The system of claim 1, wherein the stabilization tool comprises a motor.

3. The system of claim 2, wherein the motor is a piezoelectric motor.

4. The system of claim 1, wherein the stabilization tool further comprises an optical fiber extending therethrough.

5. The system of claim 1, wherein the stabilization tool further comprises a first inner needle and a second outer needle.

6. The system of claim 5, wherein the first inner needle is coupled to a drive rod of the motor.

7. The system of claim 1, wherein the intravascular imaging instrument comprises catheter operably coupled to a light source via an interface module, wherein the interface module comprises a mechanism to control an imaging operation.

8. The system of claim 7, wherein the imaging operation comprises a pullback.

9. The system of claim 7, wherein the interface module is configured to initiate a catheter pullback.

10. The system of claim 1, wherein the imaging subsystem is an OCT system.

11. The system of claim 1, further comprising a computer comprising a processor coupled to non-transitory memory.

12. The system of claim 11, wherein the computer is operable to receive data from the imaging subsystem and provide a stabilization feedback loop to dampen the vibrations.
